(19) United States
(12) Patent Application Publication
(10) Pub. No.: US 2020/0086355 A1
(43) Pub. Date: Mar. 19, 2020

(54) DEVICES AND METHODS FOR CLEANING INTERPROXIMAL AREAS

(71) Applicant: Loc Phan, Santa Clara, CA (US)

(72) Inventor: Loc Phan, Santa Clara, CA (US)

(21) Appl. No.: 16/573,848

(22) Filed: Sep. 17, 2019

Related U.S. Application Data
(60) Provisional application No. 62/733,033, filed on Sep. 18, 2018.

(51) Int. Cl. B08B 1/00; A61C 15/02; A61C 15/04

(52) U.S. Cl. CPC B08B 1/001; A61C 15/047; A61C 15/02; B08B 1/008

(57) ABSTRACT

A device for cleaning interproximal spaces between teeth. The device includes a coupling body having a coupling portion for removably coupling with a handle apparatus. An interdental member extends from the handle apparatus. Energy is transferred from the handle apparatus to the interdental member. The interdental member has a profile for fitting within and cleaning an interproximal area. The interdental member is formed from a flexible polymer material.

### CROSS-REFERENCE TO RELATED APPLICATIONS

This application claims the benefit of U.S. Provisional Application No. 62/733,033, filed on Sep. 18, 2018, which is incorporated by reference.

### BACKGROUND

The primary implement for self-cleaning teeth is the tooth-brush, however, the tooth-brush cannot sufficiently reach and therefore clean interproximal areas located between teeth. Cleaning the interproximal areas is essential for removing plaque at those areas and maintain a healthy mouth. Plaque buildup between teeth can lead to numerous dental diseases, such as gingivitis, cavities, and periodontal disease.

Cleaning interproximal areas is challenging because implement access is difficult. Dental floss is perhaps the most common implement for self-care of interproximal areas. However, dental floss is time-consuming to use and therefore can efficacy can suffer for less-patient patients. Dental floss is also subject to fray and break during use. These sorts of frustrations ultimately dissuade many persons from flossing their teeth regularly or at all. Even when used, dental floss may not be effective because of improper technique, for example the American Dental Hygienist Association recommends a detailed 4-step process for effectively using floss.

The alternative to regular flossing is regular cleaning by a dental hygienist using professional scaling devices, such as metal-tipped ultrasonic and hand scalers. However, that would be unavailable to most persons due to cost and time, and hence impractical.

### SUMMARY

Embodiments of the invention relate to devices for cleaning interproximal areas of teeth. As used herein, the term “interproximal area” is defined as areas traditionally cleaned with dental floss, including areas between the teeth large occupied by gums and periodontal spaces that can be caused by gum recession. The devices can be configured to attached to commercially available electrically powered handles intended for powering tooth-brushes. The devices can include an interdental member that has flat profile for fitting with interproximal spaces between teeth. The interdental member can be formed from a flexible polymer material.

Some embodiments relate to an apparatus for cleaning teeth. The apparatus can include a coupling body including a coupling portion. The coupling portion can be configured to removeably couple with and receive energy from a handle apparatus. At least one interdental member extends from the coupling body and is in energy communication with the coupling member such that the energy is transferable from the coupling member to the at least one interdental member. The at least one interdental member can have a profile for fitting within and cleaning an interproximal area. The at least one interdental member can be formed from a flexible polymer material.

In some embodiments, the flexible polymer material is resilient.

In some embodiments, the at least one interdental member can include positive cleaning members that extend above one or more surfaces of the interdental member.

In some embodiments, the at least one interdental member can include at least one interdental member having negative cleaning members that extend below one or more surfaces of the interdental member.

In some embodiments, the at least one interdental member can have a cross-sectional area that is perpendicular to the first direction, the cross-sectional area being defined by a first length and a second length, the first length being longer than the second length to define a flat profile.

In some embodiments, the interdental member can have a tapered tip.

In some embodiments, the first length and/or second length can reduce in size to define the tapered tip.

In some embodiments, the at least one interdental member can be a first interdental member and the interproximal area can be a first interproximal area. A second interdental member can extend from the coupling body and be in energy communication with the coupling member such that the energy is transferable from the coupling member to the second interdental member. The second interdental member can have a profile for fitting within and cleaning a second interproximal area simultaneously while the first interdental member is cleaning the first interproximal area.

In some embodiments, the second interdental member can be configured substantially identical to the first interdental member.

In some embodiments, the second interdental member can be longer or shorter than the first interdental member.

In some embodiments, the first interdental member can extend from the coupling body along a first path and the second interdental member can extend from the coupling body along a second path, where the first path and second path can diverge from one another.

In some embodiments, the first path and second path can diverge such that mid-portions of each of the first and second interdental members are separated according to a first distance, wherein the first path and the second path converge after diverging from the coupling body such that distal ends of the first and second interdental members can be separated according to a second distance that is less than the first distance.

In some embodiments, the flexible polymer material can have a durometer suitable to remove materials plaque from dental surfaces.

In some embodiments, the at least one interdental member can include a bend between a distal-most end and a proximal-most end.

In some embodiments, the bend can be an angle between 0 and 90 degrees.

In some embodiments, the bend includes a radius.

In some embodiments, the at least one interdental member can be substantially thicker between the proximal-most end and the bend as compared to the distal-most end and the bend.

In some embodiments, the flexibility of the at least one interdental member between the proximal most-end and the bend can be substantially less than flexibility of the at least one interdental member between the distal-most end and the bend.

Some embodiments relate to a a method for cleaning interproximal locations of teeth. At least one interdental member can be inserted into at least one interproximal area. The at least one interdental member can be formed from a flexible polymer material and can have a flat profile for fitting within and cleaning the at least one interproximal area. The at least one interdental member can extend from a coupling body that can include a coupling member. The coupling member can be removeably coupled to a handle apparatus. Energy can be provided to the coupling member from the handle apparatus. The energy can be transferred to the at least one interdental member from the coupling member to cause movement of the at least one interdental member within the at least one interproximal area.

In some embodiments, the at least one interdental member can be resiliently deformed by moving the handle apparatus while the at least one interdental member is within the at least one interproximal area.

In some embodiments, the at least one interdental member can include positive cleaning members that extend above one or more surfaces of the interdental member, where the cleaning members can be vibrated to remove materials from teeth surfaces of at the at least one interproximal area.

In some embodiments, the at least one interdental member can include negative cleaning members that extend below one or more surfaces of the interdental member, where the cleaning members can be vibrated remove materials from teeth surfaces of at the at least one interproximal area.

In some embodiments, the at least one interdental member can include a tapered tip that facilitates entry of the at least one interdental member into the interproximal area.

In some embodiments, the at least one interdental member can be a first interdental member and the interproximal area is a first interproximal area. The second interdental member can be inserted into a second interproximal area. The second interdental member can be configured similarly to the first interdental member. Energy can be provided to the coupling member from the handle apparatus. The energy can be transferred to the at least one coupling member from the coupling member to cause movement of the second interdental member within the second interproximal area.

In some embodiments, the second interdental member can be within the second interproximal area while the first interdental member is inserted into the first interproximal area, such that energy can be simultaneously transferred to both the first and second interproximal areas to affect simultaneous cleaning of first and second interproximal areas.

In some embodiments, the flexible polymer material can have a flexural modulus greater than or equal to 1 GPa.

In some embodiments, the flexible polymer material can have a flexural modulus ranging from 3.5-4.5 GPa.

In some embodiments, the at least one interdental member can be formed from a plurality of fibers.

In some embodiments, the plurality of fibers can taper to a point.

In some embodiments, the plurality of fibers can have a flat profile.

In some embodiments, the plurality of fibers can be coated with a cleaning product prior to inserting the at least one interdental member into the at least one interproximal area.

### BRIEF DESCRIPTION OF THE DRAWINGS

FIGS. 1A, 1B, and 1C shows a side, top, and cross-sectional views of a device usable for cleaning interproximal areas of teeth, according to some embodiments.

FIGS. 2A and 2B show top and side views of another device for cleaning interproximal areas of teeth, according to some embodiments.

FIG. 2C shows a perspective view of the device of FIGS. 2A and 2B coupled to a handle, according to some embodiments.

FIGS. 3A, 3B, and 3C show side and front views of a device for cleaning interproximal areas of teeth, according to some embodiments.

FIGS. 4A-4D show side views of various configurations of interdental members, according to some embodiments.

FIGS. 5A and 5B show cross-sectional views of an interdental member, according to some embodiments.

FIGS. 6A-6D show top and partial cross-sectional views of an interdental member, according to some embodiments.

FIG. 7 shows a side view of a device usable for cleaning interproximal areas of teeth, according to some embodiments.

FIG. 8 shows a depiction of a device having an interdental member in self-use, according to some embodiments.

### DETAILED DESCRIPTION OF THE DRAWINGS

The figures depict various embodiments for purposes of illustration only, where the figures use like reference numerals to identify like elements. Alternative embodiments of the structures and methods illustrated in the figures may be employed without departing from the principles described herein.

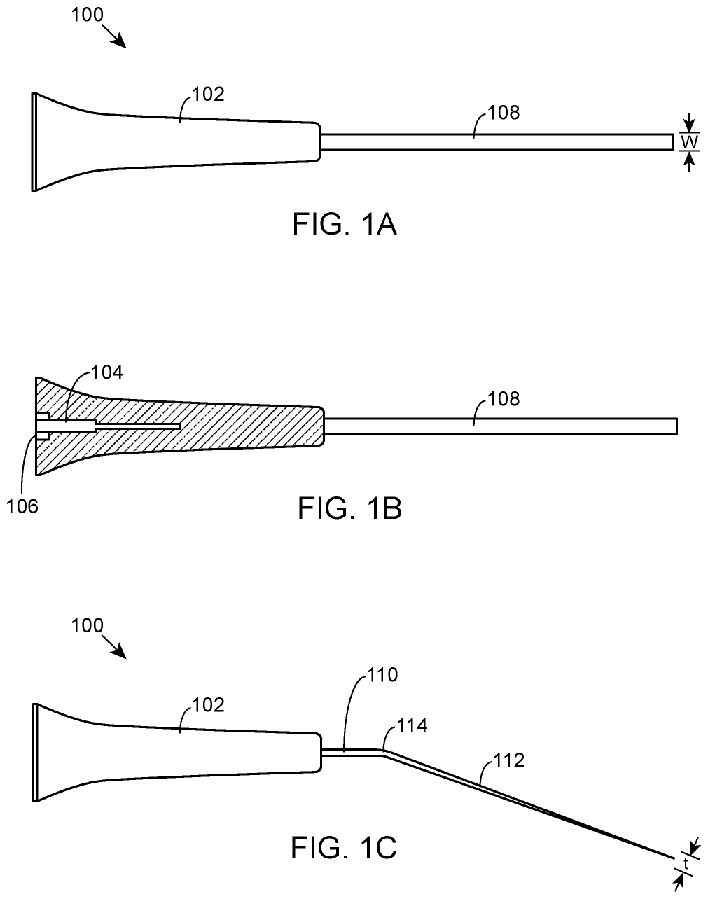

FIGS. 1A, 1B, and 1C shows a side, top, and cross-sectional views of a device 100 usable for cleaning interproximal areas of teeth. The device 100 includes a coupling body 102, which is configured to removably couple with an energy-providing powered toothbrush handle. The toothbrush handle is a commercially available handle for self-use and can be configured to provide oscillating, sonic, ultrasonic, or ultrasound energy to the device 100.

The coupling body 102 includes a coupling portion 104, which in this example is an interior surface configured to removably interface with a male interface of a toothbrush handle. Alternatively, the coupling portion can be configured as a male interface for fitting onto a female interface of a toothbrush handle. For the most part, the coupling body 102 can be constructed (e.g., printed, cast, injection molded, extruded) from a polymer material, such as acrylonitrile butadiene styrene (ABS), nylon, polycarbonate. Although the coupling body 102 is depicted as one sold body, it can be constructed from multiple components.

In this example, the coupling portion 104 can include a damper 106, which is used to tune the amount of energy transferred from the handle. The damper 106 can be constructed from metal and has a specific damping mass. However, the damper 106 is not required, and in some embodiments is not used. In some embodiments, an elastic material, such as a layer of thermoplastic elastomer (TPE), such as polydimethylsiloxane (silicone) polymer or a thermoplastic polyurethane (TPU) (e.g., PELLETHANE), can be used to dampen energy transferred by the handle. The thickness of the elastic material can be varied to tune the amount of energy transferred from the handle.

An elongated interdental member 108 extends from the coupling body 102. The interdental member 108 can be formed (e.g., co-molded) with the coupling body 102 or mechanically attached (e.g., adhered, force-fit, fastened) as a separate component. In some embodiments, the interdental member 108 is of the same material as, and integral to, coupling body 102. In all cases, the interdental member 108 is attached to the coupling body 102 to be in energy communication with the coupling portion 104. Hence, when energy provided by the handle to the coupling portion, the energy is transferred to the interdental member 108 to provide the interdental member 108 with movement to aid in removing plaques between teeth.

The interdental member 108 can be constructed (e.g., printed, cast, injection molded, extruded) from a polymer material to provide the interdental member 108 with flexibility. Generally, the polymer material with have a durometer suitable to allow the interdental member 108 to effectively remove materials plaque from dental surfaces when energy is being applied to it. The interdental member 108 can be very flexible, for example the distal tip can be drawn back 180 degrees and twisted without significant deformation occurring. Hence, the interdental member can be deformed during use to provide access to hard to reach teeth of the mouth, such as the molars. This flexibility also provides a safety benefit if the handle is dropped during use because the interdental member 108 will simply bend and not dangerously torque the teeth.

In some embodiments, the polymer is a nylon (e.g., 6, 4-6, 6-6, 6-10, 6-12, 11, 12), polyoxymethylene (POM), ultra-high-molecular-weight polyethylene (UHMWPE, UHMW), or polytetrafluoroethylene (PTFE). The material can be selected to provide the interdental member 108 with elastic resiliency, such that the interdental member 108 does not significantly inelastically deform over many uses. Alternatively, the material can be selected to provide the interdental member 108 with inelastic characteristics, such that the interdental member 108 does deform during use, for example, to allow the interdental member 108 to permanently reduce in thickness through inelastic deformation as it is drawn between teeth, thus avoiding discomfort to the user. The material can also be selected provide the interdental member 108 with lubricity to help prevent the interdental member from getting lodged between teeth. In some embodiments, the material has a flexural modulus equal to or greater than 1.0 GPa (per ASTM D790). In some embodiments, the material has a flexural modulus ranging from 3.5-4.5 GPa (per ASTM D790).

In some embodiments, the material can be doped with one or more types of particles (e.g., ceramic, salts, relatively harder polymers, relatively softer polymers, water-dissolvable minerals, metals (e.g., silver)) to provide the interdental member with one or more certain qualities while retaining one or more of the material characteristics listed above. Such particles can be micro or/or nanoparticles. The particles can provide abrasive, anti-biotic, or/or lubricous qualities to the interdental member 108.

The interdental member 108 as shown includes a proximal portion 110, distal portion 112, and a bend portion 114 in between. The bend portion 114 is shown relatively closer to the coupling body 102 rather than the distal end of the interdental member 108, however in other embodiments the bend can be placed centrally on the interdental member 108 or closer to the distal end. The bend portion 114 can be configured such that the proximal portion 110 and the distal portion 112 are separated by an angle that ranges from 0 to 90 degrees. Here, the bend portion 114 is configured to separate the proximal portion 110 and the distal portion 112 at an approximate 30-degree angle.

The cross-sectional area of the interdental member 180 can be rectangular and defined by first and second lengths, which as shown are a width w and a thickness t. Here, the thickness t is relatively smaller than width w to provide the interdental member with a substantially flat profile that allows insertion of the interdental member into interproximal areas between teeth. The width w and thickness t can be selected to fit within common sizes of interproximal areas, for example, thickness t can range from 0.1-0.8 mm and width w can range from 0.5-2.0 mm. The distal portion 112 can be configured to taper such that one or both of width w and thickness t reduce in size to aid in insertion into interproximal spaces between teeth. Here, thickness t is shown to gradually reduce in size from the bend portion 114, while width w remains constant. Alternatively, both width w and thickness t reduce in size, or only width w reduces in size to provide the taper.

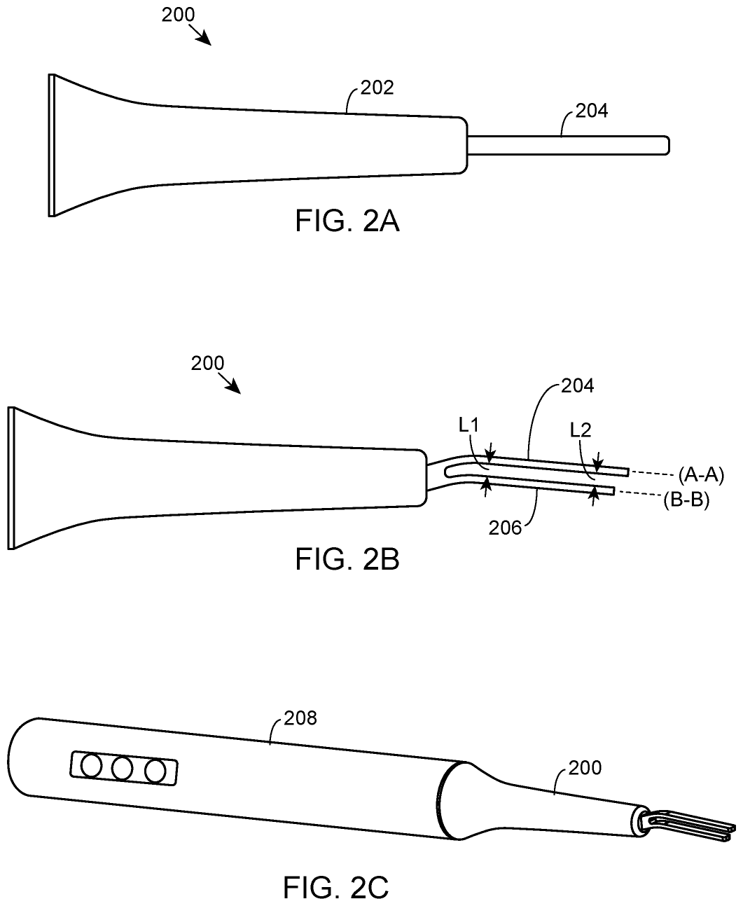

FIGS. 2A and 2B show top and side views of another device 200 for cleaning interproximal areas of teeth. The device 200 includes a coupling body 200 that can be configured in a manner that is substantially the same as the coupling body 100 of the device 100. The device 200 differs from the device 100 in that it includes more than one interdental member. Here, the device 200 includes a first interdental member 204 and a second interdental member 206. Accordingly, the device 200 can clean more than one interproximal space at a time. In this embodiment, the first interdental member 204 and the second interdental member 206 are configured to clean adjacent interproximal areas of teeth on the same jaw. However, in other embodiments, the first interdental member 204 and the second interdental member 206 can be co-planer such that their widths reside on the sample plane. This arrangement would allow simultaneous cleaning of interproximal spaces on the top and bottom jaws, or cleaning of a single interproximal space with the lower placed (i.e., towards the bite) interdental member possibly having a lesser thickness than the upper placed interdental member.

The first interdental member 204 and the second interdental member 206 can be configured in the same manner as recited herein with respect to the interdental member 108 of the device 100. The first interdental member 204 and the second interdental member 206 are not required to be configured in identical manner with respect to one another, but in some embodiments can be. Here, the second interdental member 206 has a shorter length with respect to the first interdental member 204. In other embodiments, the first interdental member 204 and the second interdental member 206 are of the same length.

The first interdental member 204 and the second interdental member 206 can be separated by a gap, which here is defined by a length L1 and a length L2. The length L1 and the length L2 can be the same or different in value. Here, the length L1 and length L2 are substantially the same. However, the length L1 can be less or greater than length L2 to provide a desired tooth-fitting characteristic. In some embodiments, length L1 is greater than length L2, and the axis A-A of the first interdental member 204 and the axis B-B of the second interdental member 206 converge. In some embodiments, the length L1 is less than length L2, then axis A-A of the first interdental member 204 and axis B-B of the second interdental member 206 will diverge. The length L1 the length L2 can be selected according to average widths of teeth of various age groups of persons. For example, the length L1 can be from 0-3 mm and L2 can be 1-4 mm.

FIG. 2C shows a perspective view of the device 200 coupled to a handle 208. The coupling of device 200 with the handle 200 is shown primarily for illustrative purposes and any of the devices disclosed herein can be coupled to the handle 208. The handle 208 can a commercially available (e.g., ORAL-B, SONICARE) electrically powered handle primarily designed to couple to removable tooth brushes. Advantages of this arrangement include user familiarity with the tooth-brushing aspect of their handle, easy interchangeability with other tooth-cleaning implements, and the lack of a need to own two separate handles. All these advantages can increase use of the device 200 and thus efficacy.

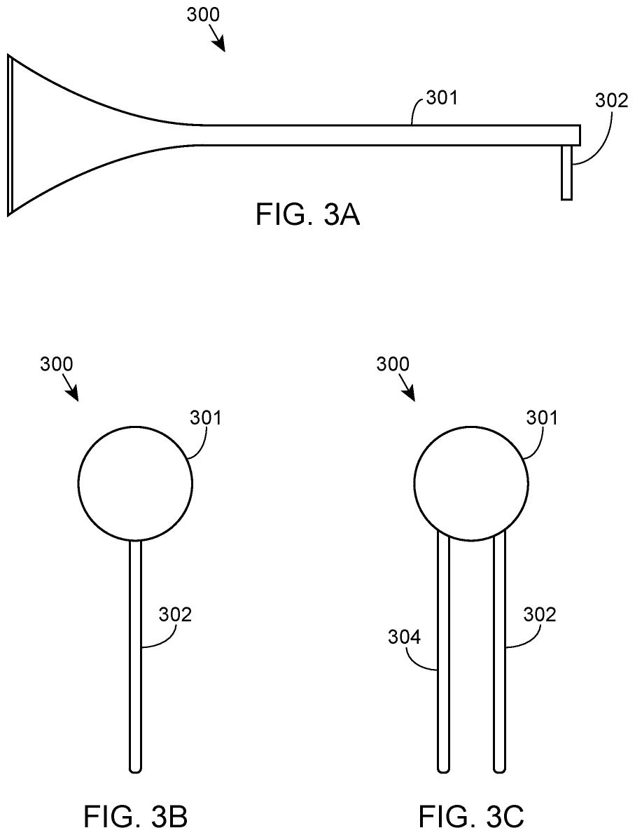

FIGS. 3A, 3B, and 3C show side and front views of a device 300 for cleaning interproximal areas of teeth. The device 300 can be configured largely the same the device 100 or the device 200, however, here a coupling body 301 of the device 300 is comparatively elongated. An interdental member 302 can extend from a distal area of the coupling body 301 at an approximate 90-degree angle. However, this is illustrative and other angles are possible, such as an angle between 30 and 60 degrees. The width of the interdental member 302 is shown being parallel to the extension of the coupling body 301, with the thickness being perpendicular. However, in other embodiments, this arrangement is reversed, with the thickness of the interdental member 302 being parallel and the thickness perpendicular. Generally, the interdental member 302 can be configured in the same manner as recited herein with respect to any other interdental member. A single interdental member 302 can be used as shown at FIG. 3B, or alternatively a second interdental member 304 can be used as shown at FIG. 3C.

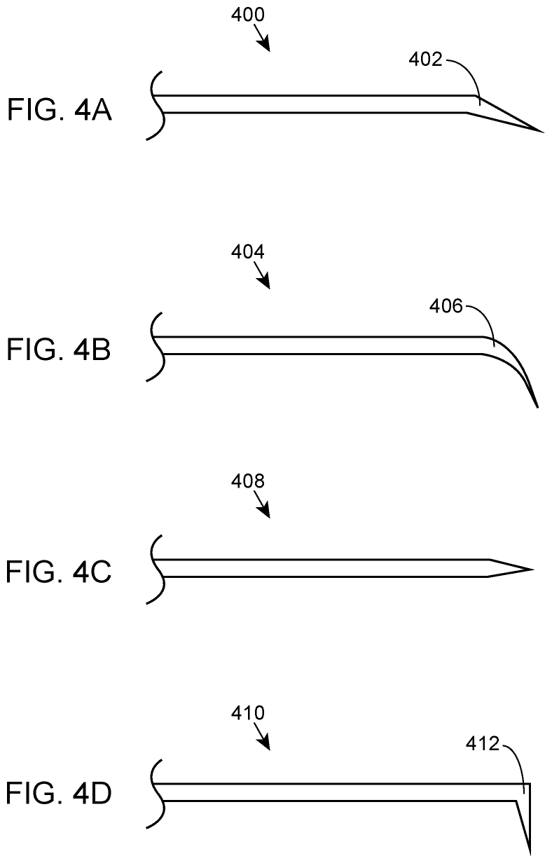

FIGS. 4A-4D show side views of various configurations of interdental members, which has aspects that are usable with any of the devices disclosed herein. FIG. 4A shows an interdental member 400 having a bend portion 402 placed relatively near the distal tip of the interdental member 400. FIG. 4B shows an interdental member 404 having a curved bend portion 406 defined by a radius. FIG. 4C shows an interdental member 408 having no bend portion. FIG. 4D shows an interdental member 410 having a bend portion 412 defined by an approximate 90-degree angle.

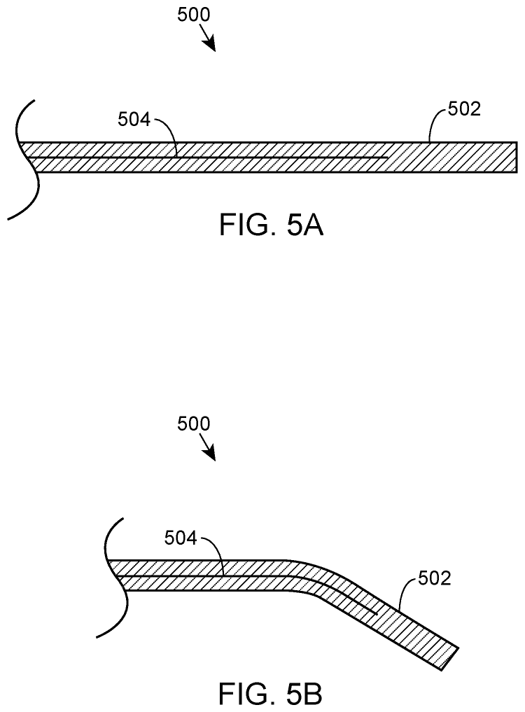

FIGS. 5A and 5B show cross-sectional views of an interdental member 500, which has aspects that are useable with any of the devices disclosed herein. The interdental member 500 is shown having a body material 502, which can be a polymer material as described above with respect to interdental member 108. The interdental member 504 additionally includes a malleable member 504, which can be a non-resilient metal wire for example. The malleable member 504 advantageously allows a user to bend the interdental member 500 according to any desired bend to access a particular interproximal area, as shown at FIG. 5B.

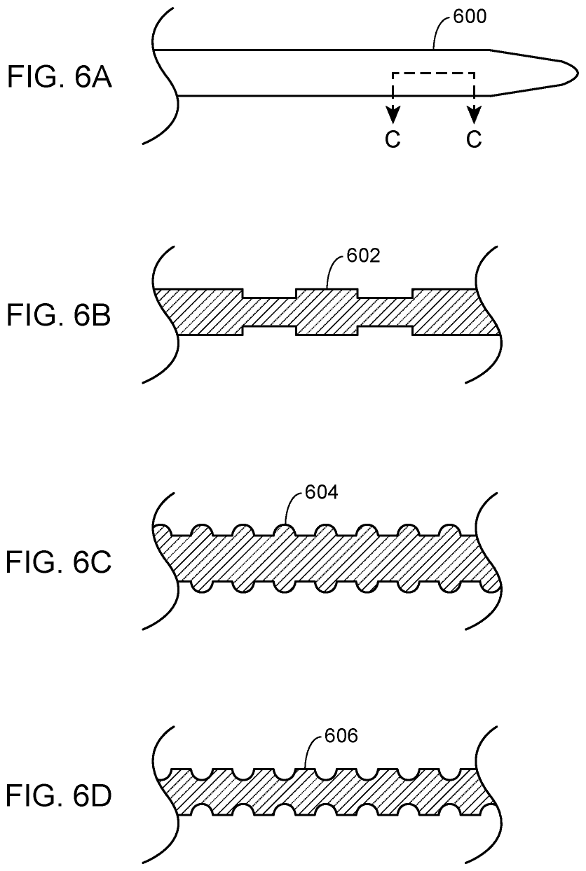

FIGS. 6A-6D show top and partial cross-sectional views of an interdental member 600, which has aspects that are useable with any of the devices disclosed herein. The interdental member 600 includes cleaning members that extend below or above the greater surface of the interdental member 600. The cleaning members can be used to help dislodge plaque by providing shapes that catch edges of the plaque. The cleaning members can also be used to hold tooth cleaning products, such as tooth-paste. In addition, the cleaning members can reduce the working thickness of the interdental member 600 to help provide access to small interproximal spaces. FIG. 6B shows the cleaning members 602 having a rectangular configuration that provides sharp edges extending above the greater surface to catch and remove plaque. FIG. 6C shows cleaning members 604 having circular profiles that extend above the greater surface of the interdental member 600 to catch and remove plaque. FIG. 6D shows an arrangement where the cleaning members 606 have circular profiles that extend below the greater surface of the interdental member 600 to catch and remove plaque.

The shapes of the various cleaning members are illustrative and other shapes are possible, such as triangular shapes for example. Further, the cleaning members can extend with the same shape across the width of the interdental member 600 or have discrete beginnings and ends. For example, the circular shapes shown at FIG. 6C can be circular ridges or partial globes. In addition, the sizes and shapes of the various cleaning members do not have to have to be uniformly patterned on a single interdental member 600. For example, a mix of the circular shapes shown of FIGS. 6C and 6D can be interspersed with 6B. In another example, the circular shapes of the cleaning members 604 vary in size.

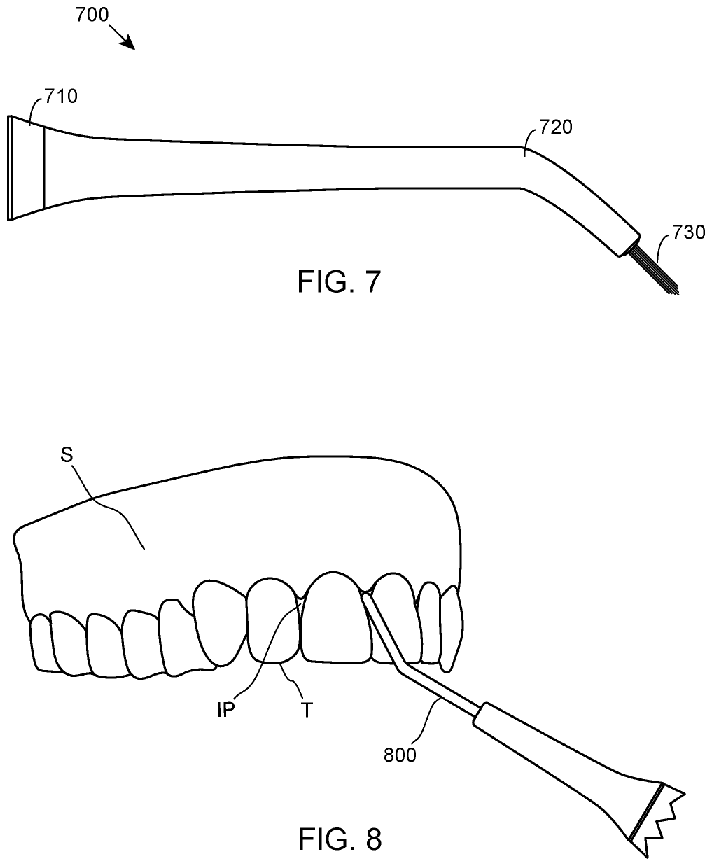

FIG. 7 shows a side view of a device 700 usable for cleaning interproximal areas of teeth. The device 700 can be configured largely the same the device 100 or the device 200, however, here a coupling body 710 of the device 700 includes an elongated neck 720. The neck 720 can be angled, as shown, or straight. In some embodiments, the neck 720 is malleable and can be moved by a user. The device 700 includes an interdental member 730 constructed from one or more fibers (e.g., 3-50 fibers). The fibers will generally be formed from flexible yet resilient or semi-resilient materials, such that the fibers retain shape after use, however, in some embodiments, non-resilient materials can be used. The fibers of the interdental member 730 can be formed from animal materials (e.g., goat, hob, horse, camel, ox, sable, and/or squirrel hairs), natural fibers (e.g., bassine, palmetto, palmyra, and/or tampico), and/or synthetic materials (carbon, nylon, PEEK, PBT, polyethelene, polypropylene, polystyrene, PTFE, and/or PVC). The fibers of the interdental member 730 can be formed to taper to a point (i.e., outer-most fibers having shorter lengths than inner fibers) or have a flat profile (i.e., each fiber having substantially the same length). In some embodiments, the fibers can be interwoven (e.g., braided). In some embodiments, the fibers can have diameters ranging from 0.4-0.8 mm and or taper from a diameter of 0.8 mm to a diameter of 0.4 mm. In use, the device 700 can be used in the same manner as the devices disclosed herein, i.e., energized and inserted into interproximal spaces for cleaning. In addition, the interdental member 730 can be coated or saturated with a cleaning solution (e.g. liquid fluoride, tooth-paste) to shape the interdental member 730 and/or assist in cleaning.

FIG. 8 shows a depiction of a device having an interdental member 800 in self-use. A portion of a mouth is shown having teeth T and gums G. Interproximal spaces IP are located between adjacent teeth T. The interdental member 800, which can have the structure of any of the interdental members disclosed herein, is inserted into an interproximal space IP while a commercially available tooth-brush handle is providing energy to the interdental member 700. The form of energy can be oscillating, sonic, ultrasonic, or ultrasound, depending on the configuration of the tooth-brush handle. The energy causes the interdental member 800 to move and dislodge plaque with very little work required by the user other than insertion. The flexibility of the interdental member allows the user to bend the interdental member 800 during use while keeping its distal end lodged in the interproximal space IP. Depending on the type of energy transmitted by the interdental member 800, effective removal of plaque can be performed within each interproximal space in as little as 1-5 seconds. Hence, providing a non-technique dependent, fast, and effective method of cleaning the interproximal spaces IP.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and illustrated herein has discrete components and features which can be readily separated from or combined with the features of any of the other several embodiments. Any recited method can be carried out in the order of events recited or in any other order that is logically possible.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in an order.

1-23. (canceled)

24. A method for cleaning interproximal locations of teeth, the method comprising:
inserting at least one interdental member into at least one interproximal area, the at least one interdental member being formed from a flexible polymer material and having a profile for fitting within and cleaning the at least one interproximal area, the at least one interdental member extending from a coupling body including a coupling member, the coupling member being removeably coupled to a handle apparatus;
providing energy to the coupling member from the handle apparatus, the energy being transferred to the at least one interdental member from the coupling member to cause movement of the at least one interdental member within the at least one interproximal area.

25. The method of claim 24, wherein the at least one interdental member is resiliently deformed by moving the handle apparatus while the at least one interdental member is within the at least one interproximal area.

26. The method of claim 24, wherein the at least one interdental member comprises positive cleaning members that extend above one or more surfaces of the interdental member, wherein the cleaning members are vibrated to remove materials from teeth surfaces of at the at least one interproximal area.

27. The method of claim 24, wherein the at least one interdental member comprises negative cleaning members that extend below one or more surfaces of the interdental member, wherein the cleaning members are vibrated remove materials from teeth surfaces of at the at least one interproximal area.

28. The method of claim 24, wherein the at least one interdental member comprises a tapered tip that facilitates entry of the at least one interdental member into the interproximal area.

29. The method of claim 24, wherein the at least one interdental member is a first interdental member and the interproximal area is a first interproximal area, and wherein the method further comprises:
inserting the second interdental member into a second interproximal area, the second interdental member being configured similarly to the first interdental member;
providing the energy to the coupling member from the handle apparatus, the energy being transferred to the at least one coupling member from the coupling member to cause movement of the second interdental member within the second interproximal area.

30. The method of claim 24, wherein the second interdental member is within the second interproximal area while the first interdental member is inserted into the first interproximal area, such that energy is simultaneously transferred to both the first and second interproximal areas to affect simultaneous cleaning of first and second interproximal areas.

31. The method of claim 24, wherein the at least one interdental member comprises a plurality of fibers.

32. The method of claim 31, further comprising coating the plurality of fibers with a cleaning product prior to inserting the at least one interdental member into the at least one interproximal area.
